(19) United States
(12) Patent Application Publication
(10) Pub. No.: US 2006/0064331 A1
(43) Pub. Date: Mar. 23, 2006

(54) Insurance premium refund incentive program

(76) Inventors: Cassie Odermott, Fruitland, ID (US); Samara Odermott, Fruitland, ID (US)

Correspondence Address: PEDERSEN & COMPANY, PLLC, P.O. BOX 2666, BOISE, ID, 83701, US

(21) Appl. No.: 11/210,146

(22) Filed: Aug. 22, 2005

Related U.S. Application Data
(60) Provisional application No. 60/603,508, filed on Aug. 20, 2004.

(51) Int. Cl. G06Q 40/00

(52) U.S. Cl. 705/4; 705/35

(57) ABSTRACT

The present invention is an insurance premium refund incentive program for consumers. Under the program, a portion of the premium, known as a “premium deposit”, typically a percentage of the premium, is received by the insurance company from the insured consumer, and held on behalf of the insured by the insurance company during the term of the policy. This “deposit” generates an agreed rate of return, and is available for refund to the insured if no claims are made and, optionally, if other prescribed conditions are met. These other conditions may be designed to encourage behavior which tends to result in reduced claims, for example, good nutrition and exercise habits for a health policy. This way, the insurance company is provided with an enhanced cash flow, and the consumer is provided with a personalized incentive to engage in behavior which tends to minimize claims.

This application claims priority of Provisional Application Ser. No. 60/603,508, filed Aug. 20, 2004, and entitled “Insurance Premium Refund Incentive Program,” which is hereby incorporated by reference.

### BACKGROUND OF THE INVENTION

1. Field of the Invention

This invention relates generally to insurance policies and insurance premiums therefor. More specifically, this invention relates to a premium refund incentive plan for consumers.

2. Related Art

Some state workers' compensation programs have “retrospective rating” features developed to encourage employers to control their industrial insurance costs through effective accident prevention and claim management. Under these plans employers may earn a refund on a portion of their standard annual premium, or be required to pay additional premium, depending upon their performance during the term of the “retrospective rating”.

Also, there are retrospective rating plans for large commercial insurance accounts. In these plans, the total premium is based on the insured's actual loss experience during the policy term, subject to a minimum and maximum premium, with the final premium determined by a formula. Therefore, the current year's premium is based upon the current year's losses, although the premium adjustments may take months or years beyond the current policy's expiration date.

Still, there is a need for an insurance premium incentive program for consumers. Also, there is a need for such a premium incentive program which provides the insurance company with up-front, paid-in cash, and yet provides an opportunity for the insured to obtain an immediate cash refund upon the policy's expiration date. This invention addresses that need.

### SUMMARY OF THE INVENTION

The present invention is an insurance premium refund incentive program for consumers. Under the program, a portion of the premium, known as a “premium deposit”, typically a percentage of the premium, is received upon initiation of the policy by the insurance company from the insured consumer. This “deposit” generates an agreed rate of return, and is available for refund immediately upon expiration of the policy to the insured if no claims are made and, optionally, if other prescribed conditions are met. These other conditions may be designed to encourage behavior which tends to result in reduced claims, for example, good nutrition, weight control and exercise habits for a health policy. This way, the insurance company is provided with an enhanced cash flow, and the consumer is provided with a personalized incentive to engage in behavior which tends to minimize claims.

### BRIEF DESCRIPTION OF THE DRAWINGS

FIG. 1 is a schematic flow diagram for one embodiment of the insurance premium refund incentive program of the present invention.

### DETAILED DESCRIPTION OF THE INVENTION

According to the present invention, a portion of the premium is identified as a “premium deposit”. Typically, the deposit is a percentage of the premium, for example, 10%. The deposit, with interest, is available for refund to the insured. Therefore, the insurance company has an opportunity to market the program as “cash-back for good behavior”, or “cash-back if no claims made”. Also, the consumer is given an opportunity to “invest” part of the premium at or near rates available only to large investors like insurance companies. Also, the insurance company will tend to develop aware and educated customers who are willing to risk the deposit amount, and plan and act for the refund. In addition, the consumer is given an individualized incentive to prevent claims, and optionally, to engage in other conduct which tends to minimize claims.

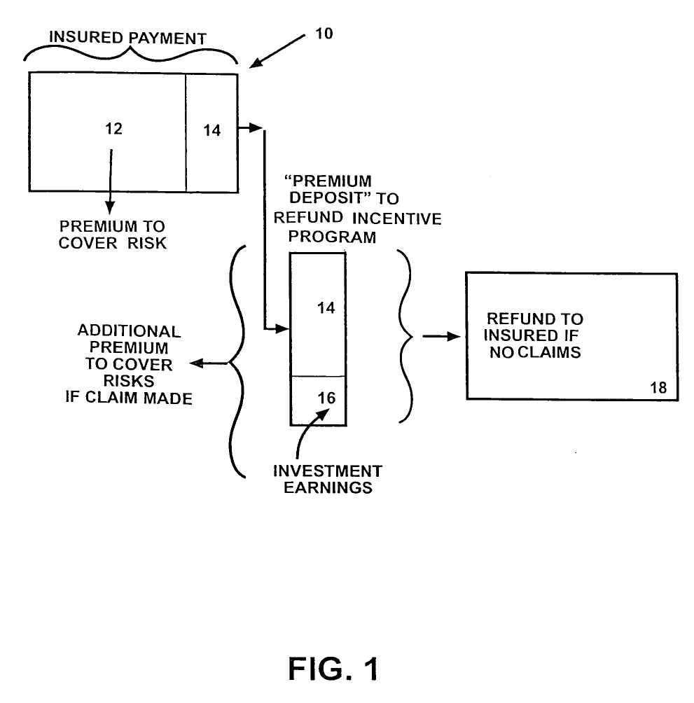

Referring to the FIG. 1, there is depicted a schematic flow diagram for one embodiment of the insurance premium refund incentive program of the present invention. According to the FIG. 1, the insured makes a payment 10 to the insurance company. The payment may be a lump sum or distributed in installments. For each payment 10, there is a portion 12 allocated to cover risk. This portion 12 immediately goes into possession of the insurance company.

Also, for each payment 10 there is a portion 14, identified as a “premium deposit”, allocated to the present premium refund incentive program. This portion may be held separately, for example, in trust for the insured by the insurance company as trustee. During the term of the policy, the “premium deposit” 14 earns interest or some other investment return or earnings 16. For example, the “premium deposit” may earn a fixed rate of return, as interest. Or, the “premium deposit” may be invested otherwise on behalf of the insured by the insurance company, according to their agreement. In any event, the aggregate amount of capital and investment skill of the insurance company will be applied on the insured's behalf, and returns better than those normally obtained by individual investors may be expected to be realized. In fact, if the insurance company encounters good fortune, then the rate of return actually obtained on the “premium deposit” may exceed the agreed amount for return to the insured, and the “premium deposit” will in that case become an additional source of revenue for the insurance company.

If the insured experiences no claims during the policy period, then, preferably immediately upon expiration of the policy, the refund 18, including the sum of the “premium deposit” 14 and investment earnings 16, as available for payment to the insured, provided all other conditions of the parties' insurance agreement are met. Conveniently, the refund may be applied to the insured's next policy's first payment. This way, over time, it is conceivable that the insured may be able to pay the entire policy premium with the refund, giving the insurance company the opportunity to also market the program as “earn your way to zero payments for insurance premiums”.

Conditions of the refund may be agreed to by the parties. An expected condition is “no claims during the policy period”. Other conditions may be considered, preferably depending upon the type of insurance policy. Many types of insurance policies may incorporate the premium refund incentive program of the present invention. For these different policies, some exemplary conditions are recited in the following TABLE A:

TABLE A

The instant invention is an incentive program for auto,
health and life insurance, for example, to help encourage
good health and safety practices.
Auto insurance would be based on the personal
clean driving record.
Home owner insurance would be based on lack of
claims on clients home.
Dental insurance would be based on better dental
care to keep from having to have root canal procedures when
possible.
Malpractice insurance would be based on doctors
being extra thorough in their operation procedures for
refunds.
Medical and Life insurance would be based on
improving the clients health and staying healthy to receive
the refunds.
An excess premium deposit would be received by the
insurance company; whether it is auto, home, life, health,
dental, or malpractice insurance; from the insured client.
This money would be held in a cash accumulation account,
whether refunded at the end of a 12 month period or kept in
the holding account to help offset the rising costs of
insurance. The client would then receive a refund from the
excess premium for good driving behavior, improved health,
dental and life practice and lack of claims on home or
malpractice insurance. Also, the insurance company may
then review the clients policy and possibly lower those
accounts that ave improved or have been consistently
improved.
HEALTH AND LIFE
Compulsive Eaters Anonymous is free to public.
They help you loose weight, eat correctly, and become
emotionally stable. They have a 12 step program to help
you keep track of the foods you eat.
Wellness checkups every 6-12 months.
Avoid using the emergency room if client can
wait to visit the doctor.
Quit smoking and be Alcohol free with possibly a
test to find out if there is any intake of either substance.
Drug free - by eating natural foods, including
vitamins and minerals, the client can avoid any or most
prescription drugs. If the clients fill out a paper and have it
signed by the nutritionist they will be able to receive their
refund at the end of the year.
DENTAL
Have frequent teeth cleaning every 6
months to l2 months to reduce the risk of cavities.
Reduce the price of teeth cleaning from
the $80.00 price.
HOME
Have an inspection done on your home
before you purchase or have licensed person bring your
home up to code in all areas, including electrical and
plumbing.
Put in smoke detectors and fire
extinguishers.
Dead bold locks on entry doors to your
home.
No claims on home.
MALPRACTICE
No claims should result in a refund at the end
of the year.
AUTO INSURANCE
No speeding tickets or personal accidents.
Other drivers causing accidents will not count
on clients record.
Glass chips or cracks; which are beyond our
control; will not count toward claims on insurance.
If these guidelines are followed on the above
listed areas of insurance programs, the client will then
receive a refund at the end of the year or a 12 month period.
In the event that the insured does lose its refund, the 12
month contract may start over the next month, after the claim.

Specifically for health and life insurance policies, some additional conditions are recited in Table B:

TABLE B
HEALTH AND LIFE INSURANCE REFUND INCENTIVE
PROGRAMS

An exercise program (managed, for example, by the health
or life insurance health club company)
a. Have a sign-in sheet for client to keep track of the
insured daily or weekly exercise program - signed by
qualified nurse or trainer.
b. Physical or wellness checkups every 3 to 6
months.
c. Required class on nutrition for eating better to
improve health and weight loss. ** (Can be a once a
month class to keep insured's updated on all health
information, and cooking for better health on a
budget.)
d. Improve health by not smoking or drinking
excessively. (If the insured wants to quit, have a
program available for client.)

A possible list of payouts to insureds and the insurance company is presented in TABLE C:

TABLE C
Payouts

| Monthly payment | | 3.5% | 6% |
|---|---|---|---|
| Premium | Extra Amount | Interest Paid | Earnings |

| 1 | 100 | 25 | 0.07 | 0.13 |
|---|---|---|---|---|
| 2 | 100 | 25 | 0.15 | 0.25 |
| 3 | 100 | 25 | 0.22 | 0.38 |
| 4 | 100 | 25 | 0.29 | 0.50 |
| 5 | 100 | 25 | 0.37 | 0.63 |
| 6 | 100 | 25 | 0.44 | 0.75 |
| 7 | 100 | 25 | 0.51 | 0.88 |
| 8 | 100 | 25 | 0.58 | 1.00 |
| 9 | 100 | 25 | 0.66 | 1.13 |
| 10 | 100 | 25 | 0.73 | 1.26 |
| 11 | 100 | 25 | 0.80 | 1.38 |
| 12 | 100 | 25 | 0.88 | 1.51 |
| Total Paid | 1200 | 300 | 5.70 | 9.79 |

| | | |
|---|---|---|
| 95% will receive | 285 | 5.42 |
| Refunds | | |
| Amount to Refund | 290.42 | |

| | |
|---|---|
| Amount Earned by Insurance Co. | 19.37 |

95% of Insured will receive 305.70 in refund

Although this invention has been described above with reference to particular means, materials and embodiments, it is to be understood that the invention is not limited to these disclosed particulars, but extends instead to all equivalents within the scope of the following claims.

What we claim is:

1. A method for incentivising an insurance policy for consumers, comprising:
a. providing an insurance policy for an insured consumer in return for a premium payment;
b. according to the policy, receiving at least a portion of the premium in trust on behalf of the insured; and
c. upon expiration of the policy, returning said portion of the premium received in trust to the insured if no claim has been made on the policy.

2. The method of claim 1 wherein additional conditions, besides no claim being made on the policy, must be satisfied before return of the premium portion received in trust.

3. The method of claim 1 wherein the premium portion received in trust, plus at least a portion of any interest or other investment return from the premium portion received in trust, is returned to the insured.
